(19) United States
(12) Patent Application Publication
(10) Pub. No.: US 2026/0340978 A1
(43) Pub. Date: Oct. 29, 2026

(54) TRAINING METHOD, FEATURE EXTRACTION METHOD, APPARATUS, DEVICE, AND MEDIUM

(71) Applicant: BYTEDANCE TECHNOLOGY LTD., Grand Cayman (KY)

(72) Inventor: Panpan HOU, Beijing (CN)

(21) Appl. No.: 19/661,604

(22) Filed: Apr. 28, 2026

(30) Foreign Application Priority Data
Apr. 28, 2025 (CN) 202510549327.2

(51) Int. Cl. G06V 10/40; G06F 40/40; G06V 10/26; G06V 10/764; G06V 10/774; G06V 10/776

(52) U.S. Cl. CPC G06V 10/40; G06F 40/40; G06V 10/26; G06V 10/764; G06V 10/774; G06V 10/776

(57) ABSTRACT

The present disclosure relates to a training method, a feature extraction method, an apparatus, a device, and a medium, and relates to the field of computer technologies. The training method of the present disclosure includes: processing, using a visual encoder of a multimodal model, visual information in a plurality of samples to obtain a visual feature of each of the plurality of samples; processing, using a text encoder of the multimodal model, a text related to content of the visual information in each sample to obtain first text features of each sample, and processing classification information of each sample to obtain second text features of each sample; fusing, using a first fusion module of the multimodal model, the visual feature of each sample with the first text feature of each sample to obtain a first fused feature of each sample; determining a contrastive loss based on the first fused feature and the second text features of the plurality of samples; and adjusting parameters of the multimodal model based on the contrastive loss to train the multimodal model.

### CROSS-REFERENCE TO RELATED APPLICATIONS

This application claims the benefit under 35USC 119 (a) of Chinese Patent Application No. 202510549327.2, filed on Apr. 28, 2025. The entire disclosure of the prior application is hereby incorporated by reference in its entirety.

### TECHNICAL FIELD

The present disclosure relates to the field of computer technologies, and in particular, to a training method, a feature extraction method, an apparatus, a device, and a medium.

### BACKGROUND

In the field of Artificial Intelligence (AI), multimodal learning is becoming increasingly important. An AI model may have the ability to understand and process various types of data, such as text, image, and video, through multimodal learning.

A multimodal model may process multimodal data and extract features of the multimodal data, and these features may be used for various downstream tasks, such as classification, recommendation, and the like.

### SUMMARY

According to some embodiments of the present disclosure, a training method is provided, including: processing, using a visual encoder of a multimodal model, visual information in a plurality of samples to obtain visual features of each sample of the plurality of samples; processing, using a text encoder of the multimodal model, a text related to content of the visual information in each sample to obtain first text features of each sample, and processing, using a text encoder of the multimodal model classification information of each sample to obtain second text features of each sample; fusing, using a first fusion module of the multimodal model, the visual features of each sample with the first text features of each sample, to obtain first fused features of each sample; determining a contrastive loss based on the first fused features and the second text features of the plurality of samples; and adjusting parameters of the multimodal model based on the contrastive loss to train the multimodal model.

According to some other embodiments of the present disclosure, a feature extraction method is provided, including: processing, using a visual encoder of a multimodal model, visual information in multimedia content to be processed to obtain visual features of the multimedia content to be processed, where the multimodal model is obtained by training using the training method of any one of the embodiments of the present disclosure; processing, using a text encoder of the multimodal model, a text related to content of the visual information in the multimedia content to be processed to obtain text features of the multimedia content to be processed; and fusing, using a first fusion module of the multimodal model, the visual features of the multimedia content to be processed with the text features of the multimedia content to be processed to obtain fused features of the multimedia content to be processed.

According to still some embodiments of the present disclosure, an electronic device is provided, including: one or more processors; and one or more memories coupled to the one or more processors and configured to store instructions, wherein the instructions, when executed by the one or more processors, cause the one or more processors to perform the training method of any one of the embodiments of the present disclosure, and/or perform the feature extraction method of any one of the embodiments of the present disclosure.

According to yet some embodiments of the present disclosure, a non-transitory computer-readable storage medium is provided, on which a computer program is stored, where the computer program, when executed by a processor, causes the processor to perform the training method of any one of the embodiments of the present disclosure, and/or perform the feature extraction method of any one of the embodiments of the present disclosure.

According to yet some embodiments of the present disclosure, a multimodal information processing system is provided, including: the electronic device which performs the training method of any one of the embodiments of the present disclosure and the electronic device which performs the feature extraction method of any one of the embodiments of the present disclosure.

Other features, aspects, and advantages of the present disclosure become clear through the following detailed description of exemplary embodiments of the present disclosure with reference to the drawings.

### BRIEF DESCRIPTION OF THE DRAWINGS

Embodiments of the present disclosure are described below with reference to the drawings. It should be understood that the drawings in the following description relate only to some embodiments of the present disclosure, but are not intended to limit the present disclosure. In the drawings:

FIG. 1 is a schematic flowchart of a training method according to some embodiments of the present disclosure;

FIG. 2 is a schematic diagram of a dimensionality reduction method according to some embodiments of the present disclosure;

FIG. 3 is a schematic diagram of a method for determining a contrastive loss according to some embodiments of the present disclosure;

FIG. 4 is a schematic diagram of a method for determining a contrastive loss according to some other embodiments of the present disclosure;

FIG. 5 is a schematic diagram of training of a multimodal model according to some embodiments of the present disclosure;

FIG. 6 is a schematic flowchart of a feature extraction method according to some embodiments of the present disclosure;

FIG. 7 is a schematic diagram of feature extraction by a multimodal model according to some embodiments of the present disclosure;

FIG. 8 is a schematic diagram of a structure of a training apparatus according to some embodiments of the present disclosure;

FIG. 9 is a schematic diagram of a structure of a feature extraction apparatus according to some embodiments of the present disclosure;

FIG. 10 is a schematic diagram of a structure of a multimodal information processing system according to some embodiments of the present disclosure;

FIG. 11 is a schematic diagram of a structure of an electronic device according to some embodiments of the present disclosure;

FIG. 12 is a schematic diagram of a structure of an electronic device according to some other embodiments of the present disclosure.

### DETAILED DESCRIPTION

The technical solutions in the embodiments of the present disclosure are clearly and completely described below with reference to the drawings in the embodiments of the present disclosure. It should be understood that the present disclosure may be implemented in various forms, and should not be construed as being limited to the embodiments set forth herein.

It should be understood that steps described in method implementations of the present disclosure may be performed in different orders and/or in parallel. In addition, the method implementations may include additional steps and/or omit performing illustrated steps. The scope of the present disclosure is not limited in this respect. Unless otherwise specifically stated, relative arrangements, numerical expressions, and numerical values of steps set forth in these embodiments are to be construed as merely exemplary, and do not limit the scope of the present disclosure.

The term “include/comprise” and its variants used in the present disclosure mean open terms that include/comprise at least subsequent elements/features but do not exclude other elements/features, that is, “include/comprise but not limited to”. The term “based on” means “at least partially based on”.

It should be noted that concepts such as “first” and “second” mentioned in the present disclosure are merely used to distinguish between different apparatuses, modules, or units, and are not used to limit an order or interdependence of functions performed by these apparatuses, modules, or units. Unless otherwise specified, the concepts such as “first” and “second” are not intended to imply that objects so described must be in a given order in terms of time, space, ranking, or in any other manner.

It should be noted that modifications of “one” and “a plurality of” mentioned in the present disclosure are illustrative rather than restrictive, and a person skilled in the art should understand that unless otherwise clearly specified in the context, the modifications should be understood as “one or more”.

Names of messages or information interacted between a plurality of apparatuses in the implementations of the present disclosure are used for illustrative purposes only, and are not used to limit the scope of these messages or information.

The embodiments of the present disclosure are described in detail below with reference to the drawings. However, the present disclosure is not limited to these specific embodiments. The following specific embodiments may be combined with each other, and the same or similar concepts or processes may not be described in detail in some embodiments. In addition, in one or more embodiments, a specific feature, structure, or characteristic may be combined in any suitable manner that will be clear to those of ordinary skill in the art from this disclosure.

A training method of a multimodal model is very important for accuracy of feature extraction of multimodal data and accuracy of downstream tasks. In the related art, in a training process of a visual and text multimodal model, after visual features are determined based on visual information and text features are determined based on a related text such as a title, the multimodal model is trained through contrastive learning between the visual features and the text features.

To further improve the accuracy of the training of the multimodal model and improve the accuracy of feature extraction of the multimodal data, the present disclosure improves the training method of the multimodal model. Visual information in a plurality of samples is processed using a visual encoder of a multimodal model to obtain visual features of each sample, and a text related to content of the visual information in each sample and classification information of each sample are separately processed using a text encoder of the multimodal model to obtain first text features and second text features of each sample. Then the visual features of each sample and the first text features of each sample are fused using a first fusion module of the multimodal model to obtain first fused features of each sample. A contrastive loss is determined based on the first fused features and the second text features of the plurality of samples. The multimodal model is trained based on the contrastive loss.

In the training method of the present disclosure, the visual features and the first text features are fused in the training process of the multimodal model, so that the multimodal model may learn semantic correlation between the visual information and the text related to content of the visual information, learn a relationship between features of different modalities, and integrate and complement the visual information and the text to make feature expression more comprehensive and complete. In addition, the classification information is added in the training process of the multimodal model. Because the classification information may more accurately distinguish multimodal data with similar content, contrastive learning between the second text features corresponding to the classification information and the first fused features is introduced, so that the multimodal model may more accurately learn a difference between different categories of multimodal data, and key features and detailed features of the multimodal data may be better extracted. With the training method of the present disclosure, accuracy of feature extraction of the multimodal data including the visual information and the text information by the multimodal model may be improved, thereby improving the accuracy of the downstream tasks. In addition, because the visual information and the text related to content of the visual information are fused in the training process, generalization ability and transfer ability of the multimodal model may also be improved, to improve performance capability in a plurality of downstream tasks.

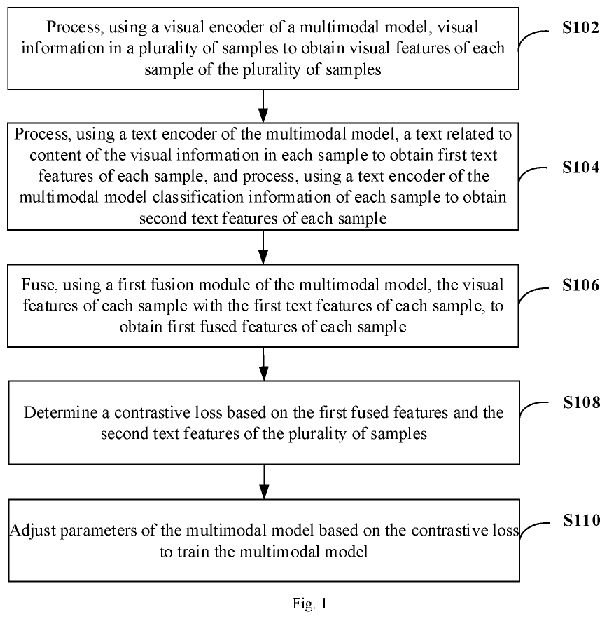

The training method of the present disclosure is described below with reference to FIG. 1 to FIG. 5.

FIG. 1 is a flowchart of some embodiments of a training method of the present disclosure. As shown in FIG. 1, the method in this embodiment includes steps S102 to S110.

In step S102, visual information in a plurality of samples is processed using a visual encoder of a multimodal model to obtain visual features of each sample of the plurality of samples.

A plurality of samples may be first determined in a multimodal training process. When the multimodal model is applied to a specific field, a plurality of samples in the specific field may be determined. For example, the plurality of samples are of a life service type, a news and information type, etc. Training the multimodal model by using the plurality of samples in the specific field may improve accuracy of the multimodal model in the specific field.

Each sample is a multimodal sample, and may include visual information and text information. For example, the visual information includes at least one of a video or an image. The multimodal model may include main parts such as a visual encoder, a text encoder, and a first fusion module. The visual encoder may be configured to extract visual features. For example, the visual information in each sample may be preprocessed to form an initial feature tensor, and the initial feature tensor is input into the visual encoder to obtain output visual features of each sample. The visual features of each sample may be visual embeddings. For example, the visual encoder is a Vision Transformer (ViT), but is not limited to the example shown.

In step S104, a text related to content of the visual information in each sample is processed using the text encoder of the multimodal model to obtain first text features of each sample, and classification information of each sample is processed to obtain second text features of each sample.

The text information of each sample includes the text related to the content of the visual information and the classification information. The text related to the content of the visual information may be a text carried in the visual information or a text carried in each sample. The classification information may be manually determined, for example, is a taxonomy title. A Bert model may be used for the text encoder, but is not limited to the example shown.

In some embodiments, the text related to the content of the visual information includes at least one of a title, text in the image, text obtained based on speech recognition, text obtained based on optical character recognition, a subtitle, or a description text. The text in the image may be a text in the visual information, or may be a text added to the visual information in a later period, for example, a text in a sticker, or a text in an image background or foreground. If each sample includes an audio, the text may be obtained based on automatic speech recognition (ASR). The text in the visual information may be recognized based on optical character recognition (OCR). The description text of the visual information may be an introduction to the visual information. The text related to the content of the visual information may further include a text corresponding to a point of interest (POI). All information that may be converted into the text and that is carried by the visual information or the sample may be used as the text related to the content of the visual information, and is not limited to the foregoing examples.

The text encoder may be configured to extract text features. For each sample, when the text related to the content of the visual information includes a plurality of types of text, the plurality of types of text may be concatenated to form a first initial text tensor, and the first initial text tensor is input into the text encoder to obtain output first text features. The text of the classification information is processed to form a second initial text tensor, and the second initial text tensor is input into the text encoder to obtain output second text features. The first text features may be first text embeddings, and the second text features may be second text embeddings.

In step S106, the visual features of each sample and the first text features of each sample are fused using a first fusion module of the multimodal model to obtain first fused features of each sample.

Because the visual features and the first text features are features of each sample, fusing the visual features and the first text features may express the features of each sample more comprehensively and accurately, and may enable the multimodal model to learn a relationship between data of two different modalities in the training process, focus on interrelated features, extract more key features that express the sample more accurately from the visual information and the text related to the content of the visual information, and help generalization and transfer ability of the subsequent multimodal model.

In step S108, a contrastive loss is determined based on the first fused features and the second text features of the plurality of samples.

The contrastive loss includes a contrastive loss function and a value of the contrastive loss function. Because the second text features are generated based on the classification information, referring to the classification information in a process of determining the contrastive loss and learning based on the contrastive loss may enable the multimodal model to learn how to distinguish samples that belong to different classifications but have similar content, thereby extracting more accurately expressed and more detailed visual features and more accurately expressed and more detailed first text features in the samples, and obtaining more accurate first fused features.

In step S110, parameters of the multimodal model are adjusted based on the contrastive loss to train the multimodal model.

The parameters of the multimodal model may be adjusted cyclically based on the contrastive loss until an iteration stop condition is met. The iteration stop condition may be that a preset quantity of iterations is reached, a value of the contrastive loss function is less than a threshold, performance on a verification set does not improve, etc. For example, in each iteration process, a gradient is calculated based on the contrastive loss function, and the parameters of the multimodal model is updated using an optimization algorithm based on the gradient. A specific method for calculating the gradient and the optimization algorithm may be performed by using an existing method, and details are not described herein.

The method in the foregoing embodiment improves the training method of the multimodal model. The visual features and the first text features are fused in the training process of the multimodal model, so that the multimodal model may learn the semantic correlation between the visual information and the text related to content of the visual information, learn the relationship between the features of different modalities, and integrate and complement the visual information and the text to make the feature expression more comprehensive and complete. In addition, the classification information is added in the training process of the multimodal model. Because the classification information may more accurately distinguish the multimodal data with similar content, contrastive learning between the second text features corresponding to the classification information and the first fused features are introduced, so that the multimodal model may more accurately learn the difference between different categories of multimodal data, and the key features and the detailed features of the multimodal data may be better extracted. With the training method in the foregoing embodiment, the accuracy of feature extraction of the multimodal data including the visual information and the text information by the multimodal model may be improved, thereby improving the accuracy of the downstream tasks. In addition, because the visual information and the text related to content of the visual information are fused in the training process, the generalization ability and the transfer ability of the multimodal model may also be improved, to improve the performance capability in the plurality of downstream tasks.

How to determine the visual features of each sample using the visual encoder is described below.

The training samples may be divided into a plurality of batches, and each batch includes a plurality of samples. One batch of samples may be used in each iteration in the training process. If each sample includes a plurality of images or videos, a preset number of images may be selected from the plurality of images or videos. A size of each image may be adjusted to a preset size. For example, a number of channels of each image is represented as C, a height of each image is represented as H, and a width of each image is represented as W, then each image may be represented as a tensor [C, H, W]. For example, the preset size is 3×224×224. If a number of samples in each batch is represented as B, and a number of images in each sample is represented as F, a tensor of one batch of samples is [B, F, C, H, W]. Each image may be divided into a plurality of patches. For example, each image is divided into 196 patches and the patches are input into the visual encoder.

If each sample includes a plurality of images (which may be a plurality of images selected from a video), a data amount processed by the multimodal model is relatively large. To further improve processing efficiency, some improved methods for performing visual encoding on each sample are provided below.

In some embodiments, the visual information includes a plurality of images, each of the plurality of images is divided into a plurality of patches, and processing, using the visual encoder of the multimodal model, the visual information in the plurality of samples to obtain the visual features of each sample of the plurality of samples includes, using the visual encoder: determining embeddings of the plurality of patches of each of the images in each of the samples; and performing average pooling on the embeddings of the plurality of patches of each image to determine embeddings of each image in each of the samples.

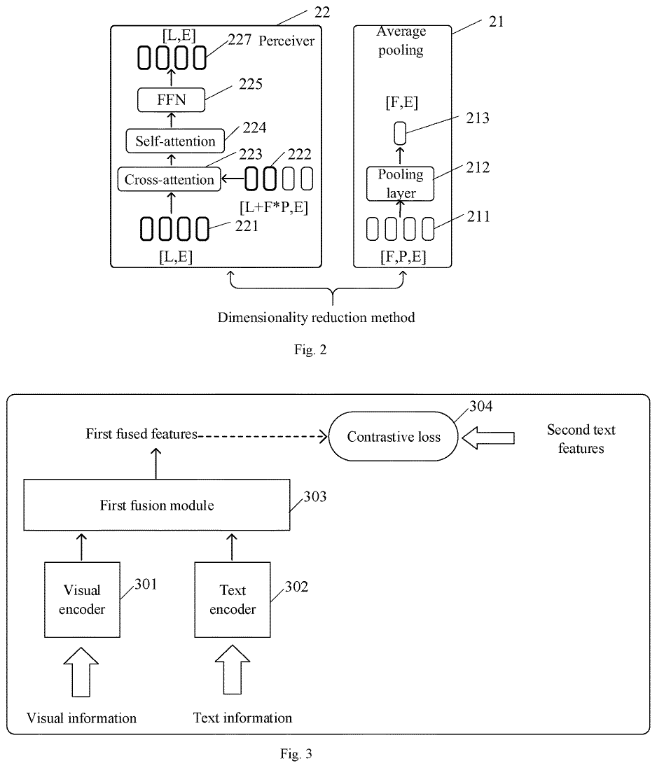

As shown in FIG. 2, two dimensionality reduction methods may be included: an average pooling method, and an average pooling module 21 in the multimodal model may be used. The average pooling module 21 includes an average pooling layer 212. For each sample, a number of images in the sample is represented as F, each image is divided into P patches, and an embedding vector of each patch is E, a feature tensor 211 of each sample may be represented as [F, P, E]. The feature tensor 211 is input into the average pooling layer 212, and an average value of the embeddings of the P patches is calculated to obtain a feature tensor 213, which may be represented as [F, E].

For example, the visual encoder is a Vision Transformer (ViT), but is not limited to the example shown. In the ViT, each patch may be mapped to a vector space of a specific dimension through a linear projection layer, for example, mapped to a 768-dimensional vector. Feature vectors of the plurality of patches of each image are added to positional encodings, and then input into a ViT encoder for further feature extraction and transformation. A feature vector of each patch output finally is 768-dimensional. A tag vector cls may further be added to the ViT model. The model of the multimodal model may learn how to encode global information of the image into a feature vector of cls, and the output feature vector of cls may also be 768-dimensional. For example, each image is divided into 196 patches, each patch may correspond to a 768-dimensional vector, cls corresponds to a 768-dimensional vector, and each sample includes 5 images, a feature tensor of each sample is [5, 197, 768], and the feature tensor is reduced to [5, 768] after average pooling, greatly reducing the feature dimensionality.

Average pooling may reduce the dimensionality of the embeddings of the plurality of patches of each image, reduce the calculation amount and memory occupancy of the multimodal model, and improve the running efficiency of the multimodal model. In addition, through the average pooling operation, the features of the plurality of patches may be aggregated, and more representative features may be extracted, which is conducive to the model better learning the global information of the image.

In some embodiments, the visual information includes a plurality of images, and processing, using the visual encoder of the multimodal model, the visual information in the plurality of samples to obtain the visual features of each sample of the plurality of samples includes, using the visual encoder, for each sample: determining embeddings of the plurality of images in the sample; concatenating the embeddings of the plurality of images in the sample with initialized embeddings corresponding to the sample to obtain concatenated embeddings of the sample; fusing, based on a cross-attention mechanism, the concatenated embeddings of the sample with the initialized embeddings to obtain first fused embeddings of the sample; and processing, based on a self-attention mechanism, the first fused embeddings of the sample to determine the visual features of the sample.

The initialized embeddings may be randomly generated, and are obtained by the multimodal model through learning as latent variables, to enable the high-dimensional feature tensor of each sample to be converted into a low-dimensional feature tensor. As shown in FIG. 2, another dimensionality reduction method is to process the feature tensor of each sample by using a perceiver22. The perceiver 22 includes a cross-attention module 223, a self-attention module 224, and a feed-forward neural network (FFN) 225. The cross-attention module 223 may include one or more cross-attention layers, and the self-attention module 224 may include one or more self-attention layers. For each sample, a number of images in the sample is represented as F, each image is divided into P patches, and an embedding vector of each patch is E. A feature tensor input into the cross-attention module 223 is initialized embeddings [L, E] and a feature tensor [L+F*P, E] obtained by concatenating embeddings of the plurality of images with the initialized embeddings corresponding to the sample. L may be configured to be equal to F. The initialized embeddings are used as latent variables, and after passing through the cross-attention module 223, the embeddings of the plurality of images of each sample may interact with the latent variables, and a representation of the latent variables is updated, so that the features of the plurality of images of each sample are fused, to obtain the first fused embeddings. The first fused embeddings may capture a long-term dependency between latent variables after passing through the self-attention module 224, to further optimize the latent variables and better represent the features of the plurality of images of each sample. Further, the FFN 225 may perform a non-linear transformation on the features output by the self-attention module 224 to finally obtain the visual features of each sample.

The dimensionality of the embeddings of the plurality of images of each sample is reduced by the perceiver, to reduce the calculation amount and memory occupancy of the multimodal model, and improve the running efficiency of the multimodal model. In addition, through the cross-attention mechanism and the self-attention mechanism, the accuracy of the visual features obtained through dimensionality reduction may be improved, focusing on important features, and improving the efficiency and generalization ability of the model.

The present disclosure provides a plurality of solutions for how to determine the contrastive loss. The solutions are specifically described below.

In some embodiments, determining the contrastive loss based on the first fused features and the second text features of the plurality of samples includes: for each sample, determining a first similarity between the first fused features of a positive sample and the second text features of the positive sample, and second similarities between the first fused features of the positive sample and the second text features of negative samples, by taking the sample as the positive sample and taking samples other than the sample in the plurality of samples as the negative samples; and determining the contrastive loss based on the first similarities and the second similarities corresponding to the plurality of samples.

The first similarity and the second similarity are, for example, cosine similarity or Euclidean distance similarity, which is not limited to the examples shown. The foregoing method for calculating the contrastive loss and the method for training based on the contrastive loss may be referred to as a label dimension CLIP (Label Dimension Contrastive Language-Image Pretraining), method. Through the contrastive loss, the first fused features of the positive sample and the second text features of the positive sample may be more similar, and the similarities between the first fused features of the positive sample and the second text features of the negative samples are lower. The multimodal model may learn more detailed features and key features for distinguishing different classifications, so that the generated first fused features are more accurate. Therefore, when the multimodal model is used for the downstream tasks, the multimodal model is more accurate. For a specific form of the contrastive loss function and a similarity calculation method, reference may be made to the prior art, and details are not described herein.

For example, the visual features of each sample and the first text features of each sample are fused based on a cross-attention mechanism, to obtain the first fused features of each sample. The visual features and the first text features may be effectively fused based on the cross-attention, so that the multimodal model may interact the visual features with the first text features, thereby generating a more accurate and more detailed first fused features for expressing each sample.

Further, more information may be added to the first fused features to further improve the accuracy of the multimodal model training. In some embodiments, processing, using the text encoder of the multimodal model, the text related to the content of the visual information in each sample to obtain the first text features of each sample includes: concatenating the text related to the content of the visual information in each sample with the classification information of each sample to obtain a concatenated text of each sample; and processing the concatenated text of each sample using the text encoder to obtain the first text features of each sample.

As shown in FIG. 3, the visual information of each sample may be input into a visual encoder 301 to obtain the visual features of each sample, and text information (a concatenated text of the text related to content of the visual information of each sample and the classification information) is input into a text encoder 302 to obtain the first text features. Then, the visual features of each sample and the first text features of each sample are input into a first fusion module 303 to obtain the first fused features. A contrastive loss module 304 may determine the contrastive loss based on the first fused features and the second text features of each sample.

Because the features of the classification information are added to the first text features, the feature of the classification information are also added to the first fused features. In the training process, the multimodal model learns the features of the classification information and a relationship between the three features while learning the visual features and the first text features, so that the multimodal model pays more attention to how to extract the visual features and the first text features related to the classification information, thereby improving the accuracy of the multimodal model and the accuracy of feature extraction of each sample.

In some embodiments, fusing, using the first fusion module of the multimodal model, the visual features of each sample with the first text features of each sample to obtain the first fused features of each sample includes: fusing, using the first fusion module, the visual features of each sample with the first text features of each sample based on a cross-attention mechanism to obtain the first fused features of each sample.

For example, the first fusion module may include one or more cross-attention layers. The visual features of each sample may be used as a query matrix Q, and the first text features of each sample may be used as a key matrix K and a value matrix V. For each sample, a similarity between the query matrix Q and the key matrix K is calculated to obtain attention scores; the attention scores are normalized by using a softmax function to obtain an attention distribution; and the first fused features of the sample are determined based on a product of the attention distribution and the value matrix V.

If the first fusion module includes a plurality of cross-attention layers, for each sample, an output of a previous cross-attention layer may be used as the query matrix of a next cross-attention layer, and the first text features are used as the key matrix K and the value matrix V, and an output of a last cross-attention layer may use features of a first layer as the first fused features of the sample. For example, a feature tensor output after passing through the one or more cross-attention layers is [B, L, D], and features of the first layer form a tensor [B, D].

The visual features and the first text features may be effectively fused based on the cross-attention, so that the multimodal model may interact the visual features with the first text features, thereby generating a more accurate and more detailed first fused features for expressing each sample.

Another solution for determining the contrastive loss is described below.

In some embodiments, determining the contrastive loss based on the first fused features and the second text features of the plurality of samples includes: fusing, using a second fusion module of the multimodal model, the visual features of each sample with the second text features of each sample to obtain second fused features of each sample; and determining the contrastive loss based on the first fused features and the second fused features of the plurality of samples.

The second fused features fuse the features of the visual information and the features of the classification information, and may enable the multimodal model to learn a relationship between the two types of visual information and the classification information in the training process, focus on interrelated features, extract more key features that express the sample more accurately from the visual information and the classification information, and help the generalization and transfer ability of the subsequent multimodal model.

In some embodiments, determining the contrastive loss based on the first fused features and the second fused features of the plurality of samples includes: for each sample, determining a third similarity between the first fused features of a positive sample and the second fused features of the positive sample, and fourth similarities between the first fused features of the positive sample and second fused features of negative samples, by taking the sample as the positive sample and taking samples other than the sample in the plurality of samples as the negative samples; and determining the contrastive loss based on the third similarities and the fourth similarities corresponding to the plurality of samples.

The third similarities and the fourth similarities are, for example, cosine similarities or Euclidean distance similarities, which are not limited to the examples shown. The foregoing method for calculating the contrastive loss and the method for training based on the contrastive loss may be referred to as a case dimension CLIP (Case Dimension Contrastive Language-Image Pretraining), method. Through the contrastive loss, the first fused features and the second fused features of the positive sample may be more similar, and the similarities between the first fused features of the positive sample and the second fused features of the negative samples are lower. The multimodal model may learn more detailed features and key features for distinguishing different classifications, so that the generated visual features, the generated first text features, and the generated first fused features are more accurate. Therefore, when the multimodal model is used for the downstream tasks, the multimodal model is more accurate. For a specific form of the contrastive loss function and a similarity calculation method, reference may be made to the prior art, and details are not described herein.

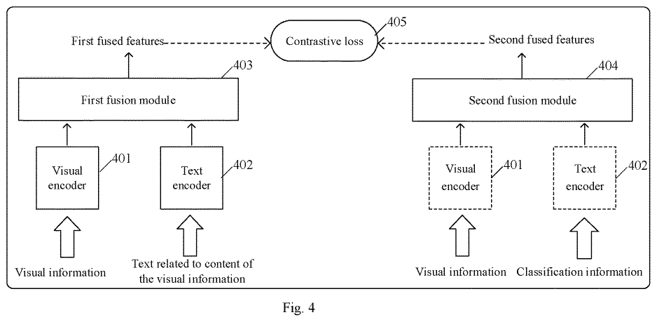

As shown in FIG. 4, the visual information of each sample may be input into a visual encoder 401 to obtain the visual features of each sample, the text related to the content of the visual information of each sample is input into a text encoder 402 to obtain the first text features, and the classification information of each sample is input into the text encoder 402 to obtain the second text features. Then, the visual features of each sample and the first text features of each sample are input into a first fusion module 403 to obtain the first fused features, and the visual features of each sample and the second text features of each sample are input into a second fusion module 404 to obtain the second fused features. A contrastive loss module 405 may determine the contrastive loss based on the first fused features and the second fused features of each sample.

In some embodiments, fusing, using the second fusion module of the multimodal model, the visual features of each sample with the second text features of each sample to obtain the second fused features of each sample includes: fusing, using the second fusion module, the visual features of each sample with the second text features of each sample based on a cross-attention mechanism, to obtain the second fused features of each sample.

For example, the second fusion module may include one or more cross-attention layers. The visual features of each sample may be used as a query matrix Q, and the second text features of each sample may be used as a key matrix K and a value matrix V. For each sample, a similarity between the query matrix Q and the key matrix K is calculated to obtain attention scores; the attention scores are normalized by using a softmax function to obtain an attention distribution; and the second fused features of the sample is determined based on a product of the attention distribution and the value matrix V.

If the second fusion module includes a plurality of cross-attention layers, for each sample, an output of a previous cross-attention layer may be used as a query matrix of a next cross-attention layer, the first text features is used as the key matrix K and the value matrix V, and features of a first layer from an output of a last cross-attention layer may be used as the second fused features of the sample.

The visual features and the second text features may be effectively fused based on the cross-attention, so that the multimodal model may interact the visual features with the second text features, and learn features more related to the classification information in the visual information, thereby extracting more accurate and detailed visual features in each sample.

Still another solution for determining the contrastive loss is described below.

In some embodiments, determining the contrastive loss based on the first fused features and the second text features of the plurality of samples includes: determining a first contrastive loss based on the first fused features and the second text features of the plurality of samples; fusing, using the second fusion module of the multimodal model, the visual features of each sample with the second text features of each sample to obtain the second fused features of each sample; determining a second contrastive loss based on the first fused features and the second fused features of the plurality of samples; and determining the contrastive loss based on the first contrastive loss and the second contrastive loss.

The foregoing method for calculating the contrastive loss and the method for training based on the contrastive loss belong to a combination of the label dimension CLIP method and the case dimension CLIP method. For example, the text related to the content of the visual information and the classification information in each sample are concatenated to obtain a concatenated text; the concatenated text is processed using the text encoder to obtain the first text features of each sample, and then the first fused features are obtained based on the visual features of each sample and the first text features of each sample. For the calculation methods of the first contrastive loss and the second contrastive loss, reference may be made to the foregoing embodiments, and details are not described herein. The first contrastive loss and the second contrastive loss may be weighted and summed, or directly summed, to obtain a total contrastive loss.

The label dimension CLIP method and the case dimension CLIP method increase the reference to the classification information in the contrastive learning process in different manners, so that the multimodal model may learn, from different perspectives, the relationship between the features of the visual information, the features of the content-related text of the visual information, and the feature of the classification information, thereby more comprehensively capturing the detailed features related to the classification information in the visual features and the text feature, and improving the accuracy of feature extraction of each sample.

In addition to using the contrastive loss to train the multimodal model in the foregoing embodiments, to further improve the accuracy of the text encoder, the training method may be further improved.

In some embodiments, a part in the text related to the content of the visual information in each sample is replaced with a mask token to obtain a masked text of each sample; the masked text of each sample is processed using the text encoder to obtain a prediction result corresponding to the mask token; a masked language model loss is determined based on the prediction result corresponding to each sample and the part of the text related to the content of the visual information, where adjusting the parameters of the multimodal model based on the contrastive loss includes: adjusting the parameters of the multimodal model based on the contrastive loss and the masked language model loss.

For each sample, a part of the text related to the content of the visual information is masked using the mask token [MASK], and the prediction is performed by the text encoder. Then, the masked language model loss (MLM Loss) is determined based on the prediction result corresponding to each sample and the part of the text related to the content of the visual information. Introducing the masked language model loss in the training process of the multimodal model may enable the text encoder to understand and predict the masked content through the context, which helps improve the understanding ability of the model on the natural language, thereby improving the accuracy of encoding of the text related to the content of the visual information, and improving the accuracy of feature extraction of each sample by the multimodal model as a whole.

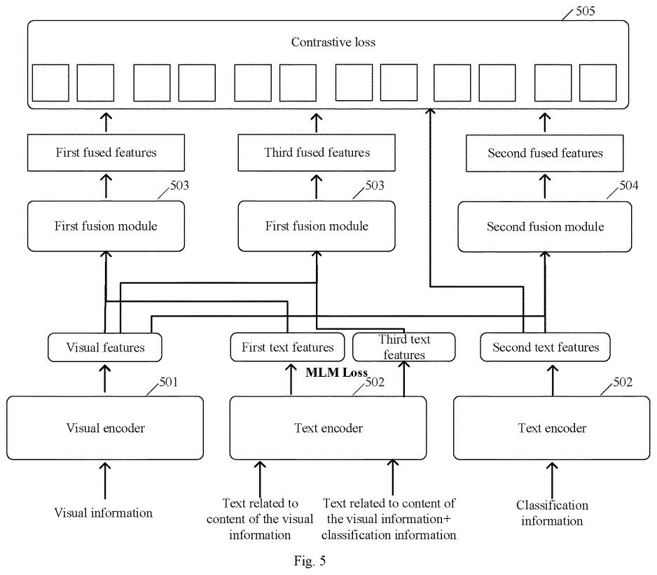

As shown in FIG. 5, in the training process, the multimodal model includes a visual encoder 501, a text encoder 502, a first fusion module 503, a second fusion module 504, and a contrastive loss module 505. The visual information in each sample is input into the visual encoder 501 to obtain the visual features of each sample. The text related to the content of the visual information in each sample is input into the text encoder 502 to obtain the first text features of each sample. The classification information of each sample is input into the text encoder 502 to obtain the second text features of each sample. The text related to the content of the visual information and the classification information in each sample are concatenated and then input into the text encoder 502 to obtain the third text features of each sample (the first text features added with the classification information in the foregoing embodiment). The visual features and the first text features of each sample are input into the first fusion module 503 to obtain the first fused features. The visual features and the second text features of each sample are input into the second fusion module 504 to obtain the second fused features. The visual features and the third text features of each sample are input into the first fusion module 503 to obtain the third fused features (the first fused features fused with the classification information in the foregoing embodiment). In the contrastive loss module 505, the first contrastive loss is determined based on the third fused features and the second text features of each sample, the second contrastive loss is determined based on the first fused features and the second fused features of each sample, and the MLM loss is further determined. The first contrastive loss, the second contrastive loss, and the MLM loss are weighted and summed to obtain the total loss. The parameters of the multimodal model are adjusted based on the total loss to train the multimodal model. For specific details, reference may be made to the foregoing embodiments, and details are not described herein.

After the multimodal model is trained, the trained multimodal model may be used to determine feature extraction of any multimedia content (multimodal data) including visual information and text information. The feature extraction method of the present disclosure is described below.

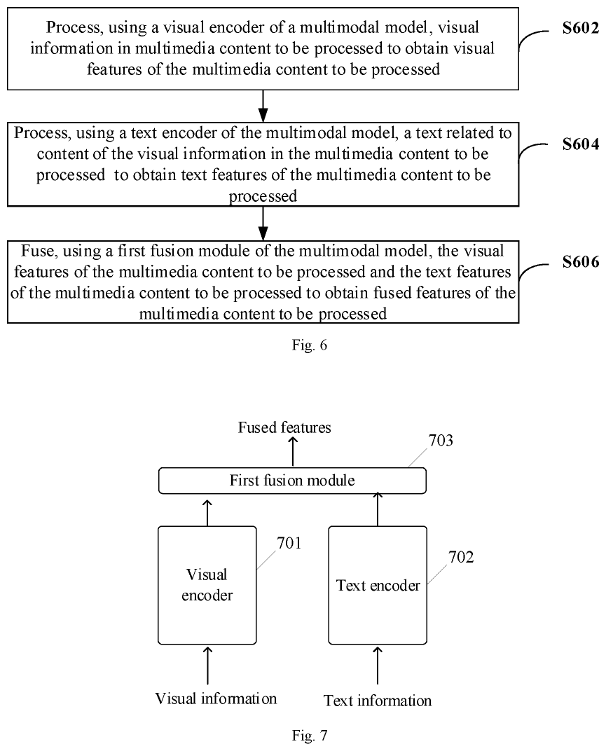

FIG. 6 is a flowchart of some embodiments of a feature extraction method of the present disclosure. As shown in FIG. 6, the method in this embodiment includes steps S602 to S606.

In step 602, visual information in multimedia content to be processed is processed using a visual encoder of a multimodal model to obtain visual features of the multimedia content to be processed.

The multimodal model is obtained by training using the training method of any one of the embodiments of the present disclosure.

In step 604, a text related to content of the visual information in the multimedia content to be processed is processed using a text encoder of the multimodal model to obtain text features of the multimedia content to be processed.

In step 606, the visual features of the multimedia content to be processed and the text features of the multimedia content to be processed are fused using a first fusion module of the multimodal model to obtain fused features of the multimedia content to be processed.

As shown in FIG. 7, the visual encoder 701, the text encoder 702, and the first fusion module 703 are mainly used in a process of using the multimodal model, and details are not described herein. Previously, the dimensionality reduction method in the foregoing embodiment may still be used in the visual encoder 701, that is, the visual encoder 701 includes the average pooling module or the perceiver. For the processing of the visual features of the multimedia content to be processed, reference may be made to the foregoing embodiment, and details are not described herein.

Because the accuracy of the multimodal model is improved in the training process of the multimodal model, for any multimedia content to be processed, the fused features may be more accurately extracted by using the multimodal model, and the features of the visual information and the text information in the multimedia content to be processed may be more accurately expressed, which helps improve the accuracy of the downstream tasks.

In some embodiments, classification information of the multimedia content to be processed is determined based on the fused features of the multimedia content to be processed.

A classifier may be added after the multimodal model to implement the classification information of the multimedia content to be processed. Because the multimodal model focuses on learning the features associated with the classification information in the multimodal data in the training process, the fused features of the multimedia content to be processed are extracted using the multimodal model, and then classification is performed, thereby improving the accuracy of classification.

In some embodiments, reply information is generated based on the fused features of the multimedia content to be processed and information input by a user.

For example, the user may generate the reply information by asking questions and performing other interactions on the multimedia content to be processed. Because the multimodal model learns how to extract the key features in the multimodal data in the training process, after the fused features of the multimedia content to be processed are extracted using the multimodal model, the interaction with the user based on the fused features may improve the accuracy of interaction.

In some embodiments, whether to recommend the multimedia content to be processed to a user is determined based on the fused features of the multimedia content to be processed and historical interaction data of the user.

For example, the historical interaction data of the user may include multimedia content historically viewed by the user, a text of a historical interaction behavior, etc., and the fused features of the multimedia content to be processed may be compared with features of the historical interaction data to determine whether to recommend the multimedia content to be processed to the user.

After the fused features of the multimedia content to be processed are extracted using the multimodal model, the fused features are compared with other features in terms of similarity to determine whether to recommend the multimedia content to be processed to the user, thereby improving the accuracy of recommendation.

In some embodiments, whether the multimedia content to be processed matches a search term is determined based on the fused features of the multimedia content to be processed and the search term.

For example, the fused features of the multimedia content to be processed may be used to perform similarity comparison with features of the search term to determine whether to use the multimedia content to be processed as a search result.

After the fused features of the multimedia content to be processed are extracted using the multimodal model, the fused features are compared with the search term in terms of similarity, thereby improving the accuracy of search.

In some embodiments, an introduction text or an introduction audio of the multimedia content to be processed is generated based on the fused features of the multimedia content to be processed.

The key features of the multimedia content to be processed may be extracted using the multimodal model, and the content is summarized using these features to generate the introduction text or the introduction audio, thereby improving the accuracy.

In addition, the trained multimodal model may be used for a plurality of downstream tasks, and is not limited to the foregoing examples. The multimodal model may also be used to process unimodal data. For example, an image may be input into the visual encoder to obtain the visual features. In the first fusion module, the visual features may be processed based on the self-attention mechanism, and then the output features of the image are obtained, which may be used for subsequent downstream tasks. Similarly, for pure text content, the features may also be extracted using the multimodal model, and details are not described herein.

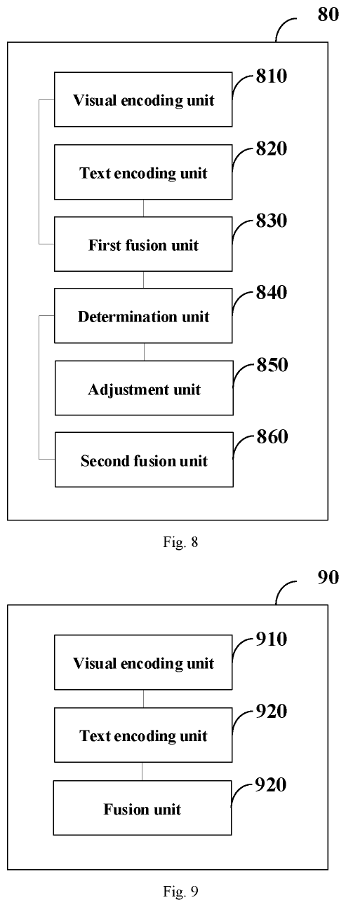

The present disclosure further provides a training apparatus, which is described below with reference to FIG. 8.

FIG. 8 is a structural diagram of some embodiments of a training apparatus of the present disclosure. As shown in FIG. 8, the training apparatus 80 in this embodiment includes a visual encoding unit 810, a text encoding unit 820, a first fusion unit 830, a determination unit 840, and an adjustment unit 850.

The visual encoding unit 810 is configured to process, using a visual encoder of a multimodal model, visual information in a plurality of samples to obtain visual features of each sample of the plurality of samples.

The text encoding unit 820 is configured to process, using a text encoder of the multimodal model, a text related to content of the visual information in each sample to obtain first text features of each sample, and process, using a text encoder of the multimodal model, classification information of each sample to obtain second text features of each sample.

The first fusion unit 830 is configured to fuse, using a first fusion module of the multimodal model, the visual features of each sample with the first text features of each sample to obtain first fused features of each sample.

The determination unit 840 is configured to determine a contrastive loss based on the first fused features and the second text features of the plurality of samples.

The adjustment unit 850 is configured to adjust parameters of the multimodal model based on the contrastive loss to train the multimodal model.

The training apparatus in the foregoing embodiment fuses the visual features and the first text features in the training process of the multimodal model, so that the multimodal model may learn the semantic correlation between the visual information and the text related to content of the visual information, learn the relationship between the features of different modalities, and integrate and complement the visual information and the text to make the feature expression more comprehensive and complete. In addition, the classification information is added in the training process of the multimodal model. Because the classification information may more accurately distinguish the multimodal data with similar content, contrastive learning between the second text features corresponding to the classification information and the first fused features are introduced, so that the multimodal model may more accurately learn the difference between different categories of multimodal data, and the key features and the detailed features of the multimodal data may be better extracted. With the training apparatus in the foregoing embodiment, the accuracy of feature extraction of the multimodal data including the visual information and the text information by the multimodal model may be improved, thereby improving the accuracy of the downstream tasks. In addition, because the visual information and the text related to content of the visual information are fused in the training process, the generalization ability and the transfer ability of the multimodal model may also be improved, to improve the performance capability in the plurality of downstream tasks.

In some embodiments, the determination unit 840 is configured to: for each sample, determine a first similarity between the first fused features of the positive sample and the second text features of the positive sample, and second similarities between the first fused features of the positive sample and second text features of negative samples by taking the sample as the positive sample and taking samples other than the sample in the plurality of samples as the negative samples; and determine the contrastive loss based on the first similarities and the second similarities corresponding to the plurality of samples.

In some embodiments, the training apparatus further includes a second fusion unit 860 configured to fuse, using a second fusion module of the multimodal model, the visual features of each sample with the second text features of each sample to obtain second fused features of each sample; and the determination unit 840 is configured to determine the contrastive loss based on the first fused features and the second fused features of the plurality of samples.

In some embodiments, the determination unit 840 is configured to: for each sample, determine a third similarity between the first fused features of the positive sample and the second fused features of the positive sample, and fourth similarities between the first fused features of the positive sample and second fused features of negative samples, by taking the sample as the positive sample and taking samples other than the sample in the plurality of samples as the negative samples; and determine the contrastive loss based on the third similarities and the fourth similarities corresponding to the plurality of samples.

In some embodiments, the training apparatus further includes a second fusion unit 860 configured to fuse, using a second fusion module of the multimodal model, the visual features of each sample with the second text features of each sample to obtain second fused features of each sample; and the determination unit 840 is configured to determine a first contrastive loss based on the first fused features and the second text features of the plurality of samples, determine a second contrastive loss based on the first fused features and the second fused features of the plurality of samples, and determine the contrastive loss based on the first contrastive loss and the second contrastive loss.

The text encoding unit 820 is configured to concatenate the related to the content of the visual information with the classification information in each sample to obtain a concatenated text of each sample, and process the concatenated text of each sample using the text encoder to obtain the first text features of each sample.

In some embodiments, the first fusion unit 830 is configured to use the first fusion module to: fuse the visual features of each sample with the first text features of each sample based on a cross-attention mechanism, to obtain the first fused features of each sample.

In some embodiments, the second fusion unit 860 is configured to fuse the visual features of each sample with the second text features of each sample based on a cross-attention mechanism, to obtain the second fused features of each sample.

In some embodiments, the determination unit 840 is further configured to replace a part of the content-related text of the visual information in each sample with a mask token to obtain a masked text of each sample, process the masked text of each sample using the text encoder to obtain a prediction result corresponding to the mask token, and determine a masked language model loss based on the prediction result corresponding to each sample and the part the text related to the content of the visual information; and the adjustment unit 850 is further configured to adjust the parameters of the multimodal model based on the contrastive loss and the masked language model loss.

In some embodiments, the visual information includes a plurality of images, each of the plurality of images is divided into a plurality of patches, and the visual encoding unit 810 is configured to use the visual encoder to: determine embeddings of the plurality of patches of each image in each sample, and perform average pooling on the embeddings of the plurality of patches of each image to determine embeddings of each image in each sample.

In some embodiments, the visual information includes a plurality of images, and the visual encoding unit 810 is configured to use the visual encoder to: for each sample, determine embeddings of the plurality of images in the sample, concatenate the embeddings of the plurality of images in the sample with initialized embeddings corresponding to the sample to obtain concatenated embeddings of the sample, fuse, based on a cross-attention mechanism, the concatenated embeddings of the sample with the initialized embeddings to obtain first fused embeddings of the sample, and process, based on a self-attention mechanism, the first fused embeddings of the sample to determine the visual features of the sample.

In some embodiments, the visual information includes an image or a video, and the text-related content of the visual information in each sample includes at least one of: a title, text in the image, text obtained based on speech recognition, text obtained based on optical character recognition, a subtitle, and description text.

The present disclosure further provides a feature extraction apparatus, which is described below with reference to FIG. 9.

FIG. 9 is a structural diagram of some embodiments of a feature extraction apparatus of the present disclosure. As shown in FIG. 9, the feature extraction apparatus 90 in this embodiment includes a visual encoding unit 910, a text encoding unit 920, and a fusion unit 930.

The visual encoding unit 910 is configured to process, using a visual encoder of a multimodal model, visual information in multimedia content to be processed to obtain visual features of the multimedia content to be processed.

The multimodal model is obtained by training using the training method of any one of the embodiments of the present disclosure;

The text encoding unit 920 is configured to process, using a text encoder of the multimodal model, a text related to content of the visual information in the multimedia content to be processed to obtain text features of the multimedia content to be processed.

The fusion unit 930 is configured to fuse, using the first fusion module of the multimodal model, the visual features of the multimedia content to be processed with the text features of the multimedia content to be processed to obtain fused features of the multimedia content to be processed.

Because the accuracy of the multimodal model is improved in the training process of the multimodal model, for any multimedia content to be processed, the fused features may be more accurately extracted by using the multimodal model, and the features of the visual information and the text information in the multimedia content to be processed may be more accurately expressed, which helps improve the accuracy of the downstream tasks.

In some embodiments, the feature extraction apparatus 90 further includes an execution unit 940 configured to perform at least one of the following: determining classification information of the multimedia content to be processed based on the fused features of the multimedia content to be processed; generating reply information based on the fused features of the multimedia content to be processed and information input by a user; determining whether to recommend the multimedia content to be processed to a user based on the fused features of the multimedia content to be processed and historical interaction data of the user; determining whether the multimedia content to be processed matches a search term based on the fused features of the multimedia content to be processed and the search term; or generating an introduction text or an introduction audio of the multimedia content to be processed based on the fused features of the multimedia content to be processed.

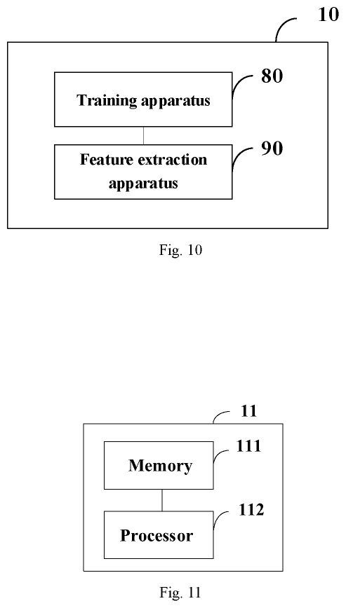

The present disclosure further provides a multimodal information processing system. As shown in FIG. 10, the multimodal information processing system 10 includes a training apparatus 80 and a feature extraction apparatus 90.

In the multimodal information processing system of the present disclosure, the visual features and the first text features are fused in the training process of the multimodal model, so that the multimodal model may learn the semantic correlation between the visual information and the text-related content of the visual information, learn the relationship between the features of different modalities, and integrate and complement the visual information and the text to make the feature expression more comprehensive and complete. In addition, the classification information is added in the training process of the multimodal model. Because the classification information may more accurately distinguish the multimodal data with similar content, contrastive learning between the second text features corresponding to the classification information and the first fused features are introduced, so that the multimodal model may more accurately learn the difference between different categories of multimodal data, and the key features and the detailed features of the multimodal data may be better extracted. In addition, because the visual information and the text-related content of the visual information are fused in the training process, the generalization ability and the transfer ability of the multimodal model may also be improved, to improve the performance capability in the plurality of downstream tasks. Because the accuracy of the multimodal model is improved in the training process of the multimodal model, for any multimedia content to be processed, the fused features may be more accurately extracted by using the multimodal model, and the features of the visual information and the text information in the multimedia content to be processed may be more accurately expressed, which helps improve the accuracy of the downstream tasks.

FIG. 11 is a block diagram of an electronic device according to some embodiments of the present disclosure. The electronic device of the present disclosure includes a processor 111 and a memory 112 coupled to the processor and configured to store instructions, where the instructions, when executed by the processor, cause the processor to perform the training method of any one of the embodiments of the present disclosure, and/or perform the feature extraction method of any one of the embodiments of the present disclosure.

The memory 111 is configured to store one or more computer-readable instructions. The memory 111 may include any combination of various forms of computer-readable storage media, for example, a volatile memory and/or a non-volatile memory, including but not limited to a random access memory (RAM), a dynamic random access memory (DRAM), a static random access memory (SRAM), a read-only memory (ROM), and a flash memory. For example, the memory 111 may store an operating system, an application, a boot loader (Boot Loader), a database, and another program, or may store various applications, various data, and the like.

The processor 112 is configured to run the computer-readable instructions to implement the song screening method of any one of the foregoing embodiments or the method of any one of the foregoing embodiments. For specific implementation of each step of the method, refer to the foregoing embodiments. Details of the same parts are not described herein.

The processor 112 may be configured to perform the steps in FIG. 1 to FIG. 9. The processor 112 may be embodied as various processing apparatuses, such as a central processing unit (CPU) and a network processor (NP); or may be a digital signal processor (DSP), an application specific integrated circuit (ASIC), a field programmable gate array (FPGA) or another programmable logic device, a discrete gate or transistor logic device, or a discrete hardware component. The central processing unit (CPU) may have an X86 or ARM architecture or the like.

The processor 112 and the memory 111 may directly or indirectly communicate with each other. For example, the processor 112 and the memory 111 may communicate through a network. The network may include a wireless network, a wired network, and/or any combination of a wireless network and a wired network. The processor 112 and the memory 111 may also communicate with each other through a system bus. This is not limited in the present disclosure.

It should be noted that the components of the electronic device 11 shown in FIG. 11 are merely exemplary and non-restrictive. The electronic device 11 may have other components according to actual application requirements. The processor 112 may control another component in the electronic device 11 to perform a desired function.

The electronic device 11 may be implemented by software, firmware, and/or hardware, and may be integrated into an apparatus in which a related application is installed.

In the electronic device of the present disclosure, the visual features and the first text features are fused in the training process of the multimodal model, so that the multimodal model may learn the semantic correlation between the visual information and the text-related content of the visual information, learn the relationship between the features of different modalities, and integrate and complement the visual information and the text to make the feature expression more comprehensive and complete. In addition, the classification information is added in the training process of the multimodal model. Because the classification information may more accurately distinguish the multimodal data with similar content, contrastive learning between the second text features corresponding to the classification information and the first fused features are introduced, so that the multimodal model may more accurately learn the difference between different categories of multimodal data, and the key features and the detailed features of the multimodal data may be better extracted. In addition, because the visual information and the text-related content of the visual information are fused in the training process, the generalization ability and the transfer ability of the multimodal model may also be improved, to improve the performance capability in the plurality of downstream tasks. Because the accuracy of the multimodal model is improved in the training process of the multimodal model, for any multimedia content to be processed, the fused features may be more accurately extracted by using the multimodal model, and the features of the visual information and the text information in the multimedia content to be processed may be more accurately expressed, which helps improve the accuracy of the downstream tasks.

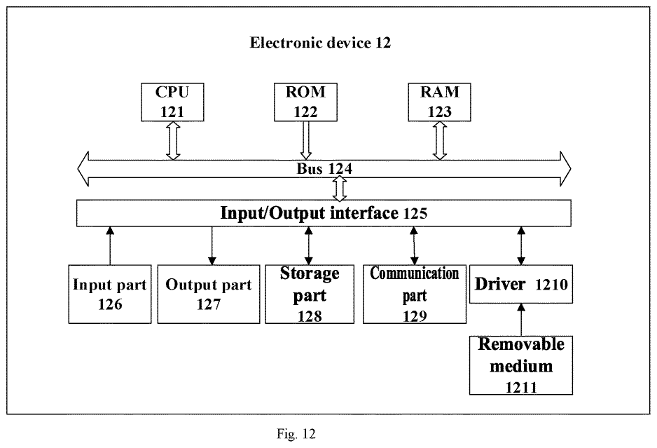

FIG. 12 is a block diagram of an electronic device according to some other embodiments of the present disclosure.

The electronic device 12 shown in FIG. 12 may be a computer system having a dedicated hardware structure, and may perform a corresponding function when a related application is installed.

The electronic device includes, but is not limited to, a mobile terminal such as a smartphone, a notebook computer, a personal digital assistant (PDA), a tablet computer (Tablet Personal Computer, Tablet PC), a PMP (portable multimedia player), a vehicle-mounted terminal (for example, a vehicle navigation terminal), and a wearable device, and a stationary terminal such as a digital television and a desktop computer.

As shown in FIG. 12, a central processing unit (CPU) 121 performs various processing according to a program stored in a read-only memory (ROM) 122 or a program loaded from a storage unit 128 into a random access memory (RAM) 123. The RAM 123 stores, as needed, data required when the CPU 121 performs the various processing. The central processing unit is merely exemplary, and may be another type of processor, such as the various processors described above. The ROM 122, the RAM 123, and the storage unit 128 may be various forms of computer-readable storage media. It should be noted that although the ROM 122, the RAM 123, and the storage unit 128 are separately shown in FIG. 12, one or more of them may be combined, or located in the same or different memories or storage modules.

The CPU 121, the ROM 122, and the RAM 123 are connected to each other via a bus 124. An input/output interface 125 is also connected to the bus 124.

The following components are connected to the input/output interface 125: an input unit 126, such as a touch screen, a touchpad, a keyboard, a mouse, an image sensor, a microphone, an accelerometer, and a gyroscope; an output unit 127, including a display, such as a cathode ray tube (CRT), a liquid crystal display (LCD), a speaker, and a vibrator; the storage unit 128, including a hard disk and a magnetic tape; and a communication unit 129, including a network interface card, such as a LAN card and a modem. The communication unit 129 allows communication processing to be performed via a network, such as the Internet. It is easily understood that although the components in the electronic device 12 shown in FIG. 12 communicate through the bus 124, they may also communicate through a network or in another manner, where the network may include a wireless network, a wired network, and/or any combination of a wireless network and a wired network.

A driver 1210 is also connected to the input/output interface 125 as needed. A removable medium 1211, such as a magnetic disk, an optical disc, a magneto-optical disc, and a semiconductor memory, is installed on the driver 1210 as needed, so that a computer program read therefrom is installed in the storage unit 128 as needed.

In the case where the foregoing series of processing is implemented by software, a program that constitutes the software may be installed from a network, such as the Internet, or a storage medium, such as the removable medium 1211.

According to the embodiments of the present disclosure, the process described above with reference to the flowchart may be implemented as a computer software program. For example, some embodiments of the present disclosure include a computer program product that, when running on a computer, causes the computer to perform the method of any one of the foregoing embodiments. The computer program product includes computer instructions carried on a computer-readable medium, and includes program code for performing the method shown in the flowchart. In such an embodiment, the computer instructions may be downloaded from a network and installed through the communication unit 129, or installed from the storage unit 128, or installed from the ROM 122. When the computer program is executed by the CPU 121, the method of the embodiments of the present disclosure is performed.

The present disclosure further provides a computer-readable storage medium, on which a computer program is stored, where the computer program, when executed by a processor, causes the processor to perform the training method of any one of the embodiments of the present disclosure, and/or perform the feature extraction method of any one of the embodiments of the present disclosure.

In the computer-readable storage medium of the present disclosure, the visual features and the first text features are fused in the training process of the multimodal model, so that the multimodal model may learn the semantic correlation between the visual information and the text-related content of the visual information, learn the relationship between the features of different modalities, and integrate and complement the visual information and the text to make the feature expression more comprehensive and complete. In addition, the classification information is added in the training process of the multimodal model. Because the classification information may more accurately distinguish the multimodal data with similar content, contrastive learning between the second text features corresponding to the classification information and the first fused features are introduced, so that the multimodal model may more accurately learn the difference between different categories of multimodal data, and the key features and the detailed features of the multimodal data may be better extracted. In addition, because the visual information and the text-related content of the visual information are fused in the training process, the generalization ability and the transfer ability of the multimodal model may also be improved, to improve the performance capability in the plurality of downstream tasks. Because the accuracy of the multimodal model is improved in the training process of the multimodal model, for any multimedia content to be processed, the fused features may be more accurately extracted by using the multimodal model, and the features of the visual information and the text information in the multimedia content to be processed may be more accurately expressed, which helps improve the accuracy of the downstream tasks.

It should be noted that in the context of the present disclosure, the computer-readable medium may be a tangible medium that may include or store a program for use by or in combination with an instruction execution system, apparatus, or device.

The computer-readable medium may be a computer-readable storage medium, a computer-readable signal medium, or any combination thereof.

The computer-readable storage medium includes, but is not limited to, an electronic, magnetic, optical, electromagnetic, infrared, or semiconductor system, apparatus, or device, or any combination thereof. More specific examples of the computer-readable storage medium may include, but are not limited to, an electrically connected portable computer magnetic disk having one or more wires, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or device. The computer-readable storage medium has computer instructions stored thereon, and the instructions, when executed by a processor, implement the method of any one of the foregoing embodiments.

The computer-readable signal medium may include a data signal propagated on a baseband or as a part of a carrier, and computer-readable program code is carried in the data signal. The data signal propagated in this manner may be in a plurality of forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained in the computer-readable medium may be transmitted in any suitable medium, including, but not limited to, a wire, an optical cable, an RF (radio frequency), or any suitable combination thereof.

The computer-readable medium may be included in the electronic device, or may exist alone without being assembled into the electronic device.

The present disclosure further provides a computer program product, including: instructions, where the program, when executed by a processor, causes the processor to perform the training method of any one of the embodiments of the present disclosure, and/or perform the feature extraction method of any one of the embodiments of the present disclosure.

In the computer program product of the present disclosure, the visual features and the first text features are fused in the training process of the multimodal model, so that the multimodal model may learn the semantic correlation between the visual information and the text-related content of the visual information, learn the relationship between the features of different modalities, and integrate and complement the visual information and the text to make the feature expression more comprehensive and complete. In addition, the classification information is added in the training process of the multimodal model. Because the classification information may more accurately distinguish the multimodal data with similar content, contrastive learning between the second text features corresponding to the classification information and the first fused features are introduced, so that the multimodal model may more accurately learn the difference between different categories of multimodal data, and the key features and the detailed features of the multimodal data may be better extracted. In addition, because the visual information and the text-related content of the visual information are fused in the training process, the generalization ability and the transfer ability of the multimodal model may also be improved, to improve the performance capability in the plurality of downstream tasks. Because the accuracy of the multimodal model is improved in the training process of the multimodal model, for any multimedia content to be processed, the fused features may be more accurately extracted by using the multimodal model, and the features of the visual information and the text information in the multimedia content to be processed may be more accurately expressed, which helps improve the accuracy of the downstream tasks.

In some embodiments, a computer program is further provided, including: instructions that, when executed by a processor, cause the processor to perform the method described in any one of the foregoing embodiments. For example, the instructions may be embodied as computer program code.

In the embodiments of the present disclosure, the computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of involving a remote computer, the remote computer may be connected to the computer of the user through any kind of network, including a local area network (LAN) or a wide area network (WAN), or may be connected to an external computer (for example, connected through the Internet with the aid of an internet service provider).

The flowchart and block diagram in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described above may be at least partially performed by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), etc.

Although some specific embodiments of the present disclosure have been described in detail by way of examples, those skilled in the art should understand that the above examples are only used for illustration, and are not used to limit the scope of the present disclosure. Those skilled in the art should understand that the foregoing embodiments may be modified without departing from the scope and spirit of the present disclosure. The scope of the present disclosure is defined by the appended claims.

What is claimed is

1. A training method, comprising:
processing, using a visual encoder of a multimodal model, visual information in a plurality of samples to obtain visual features of each sample of the plurality of samples;
processing, using a text encoder of the multimodal model, a text related to content of the visual information in each sample to obtain first text features of each sample, and processing, using a text encoder of the multimodal model classification information of each sample to obtain second text features of each sample;
fusing, using a first fusion module of the multimodal model, the visual features of each sample with the first text features of each sample, to obtain first fused features of each sample;
determining a contrastive loss based on the first fused features and the second text features of the plurality of samples; and
adjusting parameters of the multimodal model based on the contrastive loss to train the multimodal model.

2. The training method of claim 1, wherein determining the contrastive loss based on the first fused features and t he second text features of the plurality of samples comprises:
for each sample, determining a first similarity between the first fused features of a positive sample and the second text features of the positive sample, and second similarities between the first fused features of the positive sample and the second text features of negative samples, by taking the sample as the positive sample and taking samples other than the sample in the plurality of samples as the negative samples; and
determining the contrastive loss based on the first similarities and the second similarities corresponding to the plurality of samples.

3. The training method of claim 1, wherein determining the contrastive loss based on the first fused features and t he second text features of the plurality of samples comprises:
fusing, using a second fusion module of the multimodal model, the visual features of each sample with the second text features of each sample to obtain second fused features of each sample; and
determining the contrastive loss based on the first fused features and the second fused features of the plurality of samples.

4. The training method of claim 3, wherein determining the contrastive loss based on the first fused features and t he second fused features of the plurality of samples comprises:
for each sample, determining a third similarity between the first fused features of a positive sample and the second fused features of the positive sample, and fourth similarities between the first fused features of the positive sample and second fused features of negative samples, by taking the sample as the positive sample and taking samples other than the sample in the plurality of samples as the negative samples; and
determining the contrastive loss based on the third similarities and the fourth similarities corresponding to the plurality of samples.

5. The training method of claim 1, wherein determining the contrastive loss based on the first fused features and t he second text features of the plurality of samples comprises:
determining a first contrastive loss based on the first fused features and the second text features of the plurality of samples;
fusing, using a second fusion module of the multimodal model, the visual features of each sample with the second text features of each sample to obtain second fused features of each sample;
determining a second contrastive loss based on the first fused features and the second fused features of the plurality of samples; and
determining the contrastive loss based on the first contrastive loss and the second contrastive loss.

6. The training method of claim 2, wherein processing, using the text encoder of the multimodal model, the text related to the content of the visual information in each sample to obtain the first text features of each sample comprises:
concatenating the text related to the content of the visual information with the classification information in each sample to obtain a concatenated text of each sample; and
processing the concatenated text of each sample using the text encoder to obtain the first text features of each sample.

7. The training method of claim 1, wherein fusing, using the first fusion module of the multimodal model, the visual features of each sample with the first text features of each sample to obtain the first fused features of each sample comprises, using the first fusion module:
fusing, based on a cross-attention mechanism, the visual features of each sample with the first text features of each sample, to obtain the first fused features of each sample.

8. The training method of claim 3, wherein fusing, using the second fusion module of the multimodal model, the visual features of each sample with the second text features of each sample to obtain the second fused features of each sample comprises, using the second fusion module:
fusing, based on a cross-attention mechanism, the visual features of each sample with the second text features of each sample, to obtain the second fused features of each sample.

9. The training method of claim 1, further comprising:
replacing a part of the text related to the content of the visual information in each sample with a mask token to obtain a masked text of each sample;
processing the masked text of each sample using the text encoder to obtain a prediction result corresponding to the mask token;
determining a masked language model loss based on the prediction result corresponding to each sample and the part of the text related to the content of the visual information,
wherein adjusting the parameters of the multimodal model based on the contrastive loss comprises:
adjusting the parameters of the multimodal model based on the contrastive loss and the masked language model loss.

10. The training method of claim 1, wherein the visual information comprises a plurality of images, each of the plurality of images is divided into a plurality of patches, and processing, using the visual encoder of the multimodal model, the visual information in the plurality of samples to obtain the visual features of each sample of the plurality of samples comprises, using the visual encoder:
determining embeddings of the plurality of patches of each image in each sample; and
performing average pooling on the embeddings of the plurality of patches of each image to determine embeddings of each image in each sample.

11. The training method of claim 1, wherein the visual information comprises a plurality of images, and processing, using the visual encoder of the multimodal model, the visual information in the plurality of samples to obtain the visual features of each sample of the plurality of samples comprises: using the visual encoder, for each sample:
determining embeddings of the plurality of images in the sample;
concatenating the embeddings of the plurality of images in the sample with initialized embeddings corresponding to the sample to obtain concatenated embeddings of the sample;
fusing, based on a cross-attention mechanism, the concatenated embeddings of the sample with the initialized embeddings, to obtain first fused embeddings of the sample; and
processing the first fused embeddings of the sample based on a self-attention mechanism to determine the visual features of the sample.

12. The training method of claim 1, wherein the visual information comprises an image or a video, and the text-related content of the visual information in each sample comprises: at least one of a title, text in the image, text obtained based on speech recognition, text obtained based on optical character recognition, a subtitle, or description text.

13. A feature extraction method, comprising: processing, using a visual encoder of a multimodal model, visual information in multimedia content to be processed to obtain visual features of the multimedia content to be processed, wherein the multimodal model is obtained by training using the training method of claim 1;
processing, using a text encoder of the multimodal model, a text related to content of the visual information in the multimedia content to be processed to obtain text features of the multimedia content to be processed; and
fusing, using a first fusion module of the multimodal model, the visual features of the multimedia content to be processed with the text features of the multimedia content to be processed to obtain fused features of the multimedia content to be processed.

14. The feature extraction method of claim 13, further comprising at least one of the following:
determining classification information of the multimedia content to be processed based on the fused features of the multimedia content to be processed;
generating reply information based on the fused features of the multimedia content to be processed and information input by a user;
determining whether to recommend the multimedia content to be processed to a user based on the fused features of the multimedia content to be processed and historical interaction data of the user;
determining whether the multimedia content to be processed matches a search term based on the fused features of the multimedia content to be processed and the search term; and
generating an introduction text or an introduction audio of the multimedia content to be processed based on the fused features of the multimedia content to be processed.

15. An electronic device, comprising:
one or more processors; and
one or more memories coupled to the one or more processors and configured to store instructions, wherein the instructions, when executed by the one or more processors, cause the one or more processors to:
process, using a visual encoder of a multimodal model, visual information in a plurality of samples to obtain visual features of each sample of the plurality of samples;
process, using a text encoder of the multimodal model, a text related to content of the visual information in each sample to obtain first text features of each sample, and process, using a text encoder of the multimodal model classification information of each sample to obtain second text features of each sample;
fuse, using a first fusion module of the multimodal model, the visual features of each sample with the first text features of each sample, to obtain first fused features of each sample;
determine a contrastive loss based on the first fused features and the second text features of the plurality of samples; and
adjust parameters of the multimodal model based on the contrastive loss to train the multimodal model.

16. The electronic device according to claim 15, wherein determining the contrastive loss based on the first fused features and the second text features of the plurality of samples comprises:
for each sample, determining a first similarity between the first fused features of a positive sample and the second text features of the positive sample, and second similarities between the first fused features of the positive sample and the second text features of negative samples, by taking the sample as the positive sample and taking samples other than the sample in the plurality of samples as the negative samples; and
determining the contrastive loss based on the first similarities and the second similarities corresponding to the plurality of samples.

17. An electronic device, comprising: one or more processors; and one or more memories coupled to the one or more processors and configured to store instructions, wherein the instructions, when executed by the one or more processors, cause the one or more processors to: process, using a visual encoder of a multimodal model, visual information in multimedia content to be processed to obtain visual features of the multimedia content to be processed, wherein the multimodal model is obtained by training using the training method of claim 1;
process, using a text encoder of the multimodal model, a text related to content of the visual information in the multimedia content to be processed to obtain text features of the multimedia content to be processed; and
fuse, using a first fusion module of the multimodal model, the visual features of the multimedia content to be processed with the text features of the multimedia content to be processed to obtain fused features of the multimedia content to be processed.

18. A non-transitory computer-readable storage medium having a computer program stored thereon, wherein the program, when executed by a processor, causes the processor to:
process, using a visual encoder of a multimodal model, visual information in a plurality of samples to obtain visual features of each sample of the plurality of samples;
process, using a text encoder of the multimodal model, a text related to content of the visual information in each sample to obtain first text features of each sample, and process, using a text encoder of the multimodal model classification information of each sample to obtain second text features of each sample;
fuse, using a first fusion module of the multimodal model, the visual features of each sample with the first text features of each sample, to obtain first fused features of each sample;
determine a contrastive loss based on the first fused features and the second text features of the plurality of samples; and
adjust parameters of the multimodal model based on the contrastive loss to train the multimodal model.

19. A non-transitory computer-readable storage medium having a computer program stored thereon, wherein the program, when executed by a processor, causes the processor to: process, using a visual encoder of a multimodal model, visual information in multimedia content to be processed to obtain visual features of the multimedia content to be processed, wherein the multimodal model is obtained by training using the training method of claim 1;
process, using a text encoder of the multimodal model, a text related to content of the visual information in the multimedia content to be processed to obtain text features of the multimedia content to be processed; and
fuse, using a first fusion module of the multimodal model, the visual features of the multimedia content to be processed with the text features of the multimedia content to be processed to obtain fused features of the multimedia content to be processed.

20. A multimodal information processing system, comprising: the electronic device of claim 15 as a first electronic device and a second electronic device, wherein the second electronic device comprise:
one or more processors; and
one or more memories coupled to the one or more processors and configured to store instructions, wherein the instructions, when executed by the one or more processors, cause the one or more processors to:
process, using a visual encoder of a multimodal model, visual information in multimedia content to be processed to obtain visual features of the multimedia content to be processed, wherein the multimodal model is obtained by training using the first electronic device;
process, using a text encoder of the multimodal model, a text related to content of the visual information in the multimedia content to be processed to obtain text features of the multimedia content to be processed; and
fuse, using a first fusion module of the multimodal model, the visual features of the multimedia content to be processed with the text features of the multimedia content to be processed to obtain fused features of the multimedia content to be processed.
